(19) United States
(12) Patent Application Publication
(10) Pub. No.: US 2005/0271786 A1
(43) Pub. Date: Dec. 8, 2005

(54) Dough, products and methods

(75) Inventors: Douglas Lee Goedeken, Blaine, MN (US); Jean Louise Weber, Plymouth, MN (US); James Stuart Thorson, Scandia, MN (US)

Correspondence Address: Arlene Hornilla;General Mills, Number One General Mills Blvd., P.O. Box 1113, Minneapolis, MN, 55440, US

(73) Assignee: The Pillsbury Company

(21) Appl. No.: 11/201,703

(22) Filed: Aug. 11, 2005

Related U.S. Application Data
(63) Continuation of application No. 10/076,127, filed on Feb. 14, 2002.

(51) Int. Cl. A21D 10/00

(52) U.S. Cl. 426/549

(57) ABSTRACT

The present invention provides a dough composition comprising propylene glycol alginate in an amount of 0.005 to 0.2% by weight of the total dough composition. Baked dough products according to present invention are springy in texture. Methods of preparing a baked dough product using the dough composition as described, and products made by this method are also provided.

### PRIORITY CLAIM

The present Continuation Patent Application claims the benefit of U.S. patent application Ser. No. 10/076,127, filed Feb. 14, 2002, entitled DOUGH, PRODUCTS AND METHODS, the entirety of said prior patent application is incorporated herein by reference.

### FIELD OF THE INVENTION

The present invention relates to dough compositions. More specifically, the present invention relates to dough compositions that provide baked dough products that are springy in texture.

### BACKGROUND OF THE INVENTION

Leavened dough products have been prepared for thousands of years to provide both nutrition and pleasure in eating. The process of preparing and baking such products involves a number of potentially arduous steps. People have developed a specific expectation as to both the texture and flavor of the dough products that they wish to eat.

Dry mixes for the preparation of baked goods having yeasty flavor that do not require dough kneading or lengthy fermentation steps are disclosed in U.S. Pat. No. 4,481,222. The mixtures disclosed therein comprise flour, chemical leavening agents, active dry yeast, and a selected gum mixture comprising propylene glycol alginate, and a member selected from the group consisting of karaya gum, guar gum, xanthan gum, carboxymethyl cellulose, carrageenan gum, and mixtures thereof. This patent claims mixtures comprising about 0.3 parts to 2.8 parts by weight per 100 parts of flour of the propylene glycol alginate and about 0.7 parts to 4.15 parts of a gum member by weight per 100 parts of flour. The specification states that “The particular gum mixture has surprisingly allowed for provision of yeasty baked goods of both desirably high specific volume and desirable bread-like texture without requiring odious dough kneading steps.” The examples, particularly Example IV, show the criticality of the presence of both the propylene glycol alginate and the specified gums, stating that “In order to make a finished bread product with proper properties, both total gum and PGA concentrations must be in the ranges given herein.”

### SUMMARY OF THE INVENTION

Consumers desire the unique flavor and texture of bread and breadlike products. The ability to achieve both properties at the same time is challenging. This is particularly the case where the product will be stored for some time prior to consumption. Refrigeration and freezing of dough products presents particular challenges in providing a product that has both the flavor and the texture desired by consumers.

It has surprisingly been found that the addition of a very small amount of propylene glycol alginate (“PGA”) to a dough composition provides excellent textural benefits in the dough product after baking. The inventive formulation provides a baked dough product having the benefit of a springy texture without introducing gumminess or diminished flavor.

More specifically, the present invention provides a dough composition comprising a) flour, water and a leavening system in amounts sufficient to provide a leavened dough composition; and b) 0.005 to 0.2% by weight of propylene glycol alginate. The dough composition of the present invention is at least partially developed.

### BRIEF DESCRIPTION OF THE DRAWING

FIG. 1 shows a force vs. strain curve for evaluation of the springiness of a dough product.

### DETAILED DESCRIPTION OF THE INVENTION

For purposes of the present invention, a dough composition and dough products made from a dough composition are distinguished from a batter composition and batter products made from a batter composition in that dough products are at least partially developed. A dough composition as for purposes of the present invention differs from a batter composition in that the dough composition prior to cooking exhibits elastic memory. Thus, an uncooked dough composition when stretched or compressed will at least partially recover its previous shape after removal of the stretching or compression force. In a dough composition, the ability to retain the gases as part of the leavening process is provided by the interconnected structure of the gluten and proteins in the flour composition, which structure is generated during the work put into the dough system during mixing. This interconnected gluten structure may be observed microscopically, by utilizing a stain specific to gluten in a manner well known in the art. The physical property characteristics of the uncooked dough composition provide unique flavor and textural properties in the final product. In particular, the dough product has a cohesiveness unique to bread and breadlike products. Batter compositions, in contrast, are not developed, and therefore flow without exhibiting elastic memory. Microscopic evaluation of the batter composition will reveal isolated concentrations of gluten, without formation of the desired interconnected structure required to indicate dough development. Examples of batter products include cake mixes, pancakes, waffles and the like. These products are, in general, not as cohesive as dough products, and cannot achieve the same flavor characteristics. While cohesiveness may be imparted to batter products by formation of an interconnecting polymer network through incorporation of gums or polymers in the batter composition, flavor may be adversely affected, with the resulting texture of the batter product still not achieving the desired texture that can only be realized by a dough product as defined herein.

Baked dough products having a baked specific volume (“BSV”) of about 2.5 to about 6 cc/g are particularly desired by consumers. These products preferably are not too dense, and also should have a somewhat springy texture. Above all, the product must have a desirable flavor so that the entire product exhibits the desired organoleptic properties. Specifically, the consumer particularly desires to experience a certain amount of resistance when biting into the baked product, with a somewhat springy return of the product after application of pressure, either by hand or in the process of mastication. It is difficult to achieve this textural property while maintaining the desired flavor of the baked product. Thus, while more resiliency may be provided by addition of various chemicals such as gums to the dough product, the addition of such chemicals may result in the introduction of off flavors and/or undesired ancillary textures to the baked product. As a particular problem, the incorporation of such chemicals may cause gumminess in a dough product. A baked dough product is considered to be gummy if upon compression, the product sticks to itself rather than at least partially recovering the shape it had prior to compression. A very gummy product may be easily compressed into a ball shape, which shape will be maintained after removal of the compressive force. Preferably, the baked dough product of the present invention is sufficiently free of gumminess such that a product compressed to ¼ of its uncompressed thickness will recover to at least ½ of its uncompressed thickness, and more preferably to at least ¾ of its uncompressed thickness.

It has been found that the addition of PGA to a dough product composition as defined herein provides significant improvement in texture of the resulting baked dough product. Thus, in the present invention, the addition of PGA significantly improves the springiness of the baked product. The formulation of the present invention has been found to result in a less gummy baked dough product as compared to product containing gums, and additionally has been found to result in a springy baked dough product as compared to products not containing propylene glycol alginate in the amount indicated.

For purposes of present invention, a dough composition that is “at least partially developed” is a composition that has been kneaded or otherwise had work imparted to it to provide a degree of plasticity and elasticity of the dough composition, with a toughening to facilitate the capture of gases during the proofing process to leaven the dough. Dough compositions that are at least partially developed provide unique textural properties that are highly desired by consumers.

BSV is a term of art generally known in the industry to define the inverse of density or fluffiness of a baked good, and is simply the volume of the baked product divided by its weight. The determination of BSV is of course done only on the dough portion of the baked product, and does not include any filling, if present in the amounts sufficient to substantially alter the BSV value of the product. The dough product of the present invention, when baked, preferably has a BSV of about 2.5 to about 6 cc/g, and more preferably has a BSV of about 3 to about 5 cc/g.

Springiness is a property measuring the elastic properties of the baked dough product. Baked dough products of the present invention that are biscuits preferably have a Springiness Value of from about 0.35 to about 0.45 as determined by the Springiness Evaluation described below. Baked dough products of the present invention that are dinner rolls and conventional breads preferably have a Springiness Value of from about 0.45 to about 0.55, and more preferably from about 0.46 to about 0.52. The difference in the preferred springiness values of these product categories result from the different compositional nature of these products, as well as the different expectations of the characteristics of these products in the eyes of the consumer.

The evaluation of the properties of the baked dough product of the present invention is made after individual sized dough portions are baked in an appropriate manner, time and temperature as is readily apparent to the routineer in this art. Thus, baking takes place at a temperature appropriate for the specific food product, typically 350° F. in a conventional oven or a convection oven, for a time sufficient to completely cook the product while not overcooking the product.

Dough products of the present invention may be selected from any product type that would benefit from enhanced springiness. Preferred baked dough products include breads, rolls, buns, croissants, Danishes, biscuits, and the like. These dough products may be either filled or unfilled, as discussed below. While baking is a preferred method of cooking the dough products of the present invention, any cooking technique appropriate for the category of dough product to be prepared may be used. For example, dough products the present invention may be cooked by frying, steaming, microwave cooking, conductive baking, heating by infrared radiation or any other appropriate cooking method.

A particularly preferred embodiment of the baked dough products is biscuits. Biscuits that are intended to have a high BSV (as distinguished from cracker style biscuits) have achieved a high degree of acceptance in the consumer arena. They have a unique flavor, and provide distinct manufacturing advantages as compared to bread products because they are easy to prepare. Substantial improvement in high volume biscuit products would be obtained if the texture of the baked product could be enhanced by providing a springiness aspect to the biscuit without introducing gumminess or off flavor.

Non-laminated biscuits are characterized by being an underdeveloped dough product. Thus, the biscuit dough is prepared by mixing the dough composition only enough to incorporate all the ingredients with partial development of the gluten in the dough. In preferred biscuit compositions of the present invention, the biscuit dough is not fully developed. As is appreciated by those of skill in the baking art, a biscuit dough is distinct from bread-like doughs due to the degree of development of the dough. A tool to quantify the nature of the extent of development of the dough is a farinograph, which is a common flour and dough quality measuring device that measures the resistance of the dough to mixing. As dough is mixed, the resistance to mixing increases until a peak is reached, after which the resistance to mixing decreases. Typical bread doughs tend to peak within about 3 minutes, indicating that the dough is fully developed. A biscuit dough, in contrast, will take longer to reach a peak resistance, indicating that the dough is underdeveloped. Biscuit doughs typically reach a peak of resistance in a time period greater than about 7 minutes, and preferably greater than about 10 minutes. The biscuit dough is mixed using a mixer suitable for the size batch to be prepared.

Another preferred dough product of the present invention has a laminated texture in the final baked or cooked product. This has traditionally been achieved by forming alternating layers of fat and dough. This laminating can be done by hand or machine and in continuous operations of high volume output it is desirable to prepare the laminated product by machine. One such machine is described in U.S. Pat. No. 4,622,890. A particularly preferred embodiment of the present invention is a dough product that is a laminated biscuit.

For purposes of the present invention, the term “unproofed” means that the dough is provided in a state wherein it contains sufficient unactivated leavening agent that the dough product will at least double in volume when allowed to proof, or in embodiments without an intermediate proofing step, the dough product will double in volume during baking. Thus, while some chemical leavening agent may have interacted with ingredients in the dough forming process during mixing to generate some gases, or likewise yeast may have similarly generated some gases, a sufficient amount of the leavening agent is still available to be utilized to provide expansion of the dough at the indicated time.

For purposes of the present invention, the term “refrigerated” describes dough products that are maintained at a temperature below about 50° F. and above the freezing point of water.

For purposes of the present invention, the term “frozen” describes dough products that are maintained at a temperature at or below the freezing point of water, regardless of whether all ingredients in the dough product are actually in the frozen state.

As noted above, propylene glycol alginate surprisingly has been discovered to have a profound impact on the textual properties of the dough product of the present invention when present only in a very small amount based on the total weight of the dough. Propylene glycol alginate is available commercially from many sources, including International Specialty Products (ISP), San Diego, Calif. While propylene glycol alginate may be present in the composition at levels from 0.005 to 0.2 percent, the actual amount of PGA present in the dough composition will be dependent on the specific dough product to be produced. For example, a laminated biscuits will preferably contain from about 0.01 to about 0.10 percent PGA in the composition. In general, dough products having high water activity in at least one component of the overall product may benefit by comprising a higher range of PGA in the composition. For example, dough products containing fillings that have a high water activity may particularly benefit from the dough component of the overall product containing a higher quantity of PGA. In such products, the dough composition will preferably contain from about 0.05 to about 0.15 percent of PGA in the dough composition.

Dough conditioners may also be incorporated in the doughs of the present invention. Preferred dough conditioners are emulsifiers, which have been surprisingly found to enhance the consumer acceptance of the dough product when used in conjunction with propylene glycol alginate. Specifically, in laminated biscuit products, it has been found that the combination of PGA plus a dough conditioner that is an emulsifier surprisingly provides exceptional consumer acceptance as compared to a laminated biscuit product containing only PGA or containing only the dough conditioner. Preferred emulsifiers include, for example, mono- and diglycerides, mono- and di-glycerides of fatty acids, propylene glycol mono- and di-esters of fatty acids, glycerol-lacto esters of fatty acids, ethoxylated mono-glycerides, lecithin, protein, and mixtures thereof. Preferred emulsifiers include mono-glycerides and mixtures of propylene glycol mono- and di-esters of fatty acids, and lecithin. Particularly preferred dough conditioners include sodium stearoyl 2 lactylate, calcium stearoyl lactate, ethoxylated and succinylated monoglycerides, polysorbate 60, and mixtures thereof. A most particularly preferred dough conditioner is sodium stearoyl lactylate (SSL)-mono/diglycerides. The dough may preferably comprise emulsifiers in an amount of from about 0.1 percent to about 2.5 percent by weight of the dough.

The flour to be used may be any suitable flour for manufacture of dough products. Generally, the dough of the invention comprises a processed or unprocessed flour, which may either be a white flour or a whole grain constituent. Wheat flour is preferred, although non-wheat flours may be used in conjunction with wheat flours or alone if desired. Appropriate flours for use in the present invention include whole grain flours, flours with the bran and/or germ removed, bleached or unbleached, or combinations thereof. In the event that a non-wheat flour is used, addition of gluten may be desirable. Grains useful for the dough of the invention include wheats, oats, rye, sorghum, barley, rice, millet, and corn among others. The dough composition preferably has a flour to water ratio of from about 1.5 to about 2.5, and more preferably from about 1.5 to 2.

Water is a necessary ingredient in doughs of the present invention. Water is added to the dough as liquid water, ice, or it is added via hydrated ingredients. Ice is added to supply water to doughs in order to keep the combination cool during mixing. Water is present in the dough in the amount up to about 50 percent by weight. More preferably, water comprises from about 25 to about 45 percent by weight based on total dough composition weight.

Depending upon the type of leavening desired, a leavening agent can be added to the dough to provide the desired production of carbon dioxide to leaven the dough. The leavening agent may be either yeast or a chemical leavening agent, or a combination of the two. In addition or alternatively, the leavening agent may be the injection of carbon dioxide gas or other suitable gas during the dough formation process (especially extrusion process) to provide the desired gas cell structure in the final product.

For purposes of the present invention, a chemical leavening agent is a combination of chemical ingredients that react to produce carbon dioxide. Preferably, these chemical ingredients are a combination of an acid and a base that react to release carbon dioxide into the dough and thereby increase the volume of the dough. Suitable leavening acids are generally known in the industry and include but are not limited to citric acid, sodium acid pyrophosphate (SAPP), sodium aluminum phosphate (SALP), monocalcium phosphate (MCP), dicalcium phosphate (DCP), sodium aluminum sulfate (SAS), anhydrous monocalcium phosphate (AMCP), dimagnesium phosphate (DMP), dicalcium phosphate dihydrate (DCPD), gluconodelta lactone (GDL) and mixtures thereof. Suitable bases used in leavening agents generally include a carbonate and/or a bicarbonate salt. Suitable carbonate and bicarbonate salts include, for example, sodium carbonate, potassium carbonate, sodium bicarbonate (commonly known as baking soda), potassium bicarbonate, ammonium bicarbonate and mixtures thereof. An example of a preferred chemical leavening agent is the combination of sodium bicarbonate and glucono-delta-lactone.

Yeast may be used either alone or in conjunction with a chemical leavening agent to leaven the dough of the present invention. Yeast provides particular flavor and textural benefits, even when not acting as the primary leavening system for the bread product. Any suitable yeast and format thereof may be utilized, including baker's yeast, activated yeast, crumbled yeast, and so forth. When yeast is used as the sole or primary leavening agent in the dough of the present invention, time for proofing the dough may be required before cooking of the raw dough product to obtain the desired baked specific volume. The time required for proofing depends on the composition of the dough, and may be readily determined by the practitioner.

When the leavening agent used is yeast or a chemical leavening agent, the leavening agent preferably is provided as about 1% to about 6% by weight of the dough.

Fat, when provided as a component of the dough, improves the volume of the dough and enhances the mouthfeel, texture, and flavor of the baked product. Fats may be provided in the form of oil, or more preferably as shortening. Fat preferably is present in the dough composition as about 1 to about 12% fat, based on total dough composition weight. A shortening that is solid at room temperature (i.e. “plastic”) is preferred and is used in the range of 12% to 20% by weight of the dough. The plastic shortening could be emulsified or non-emulsified and have the form of a chip, pellet, flake or any variation thereof. The fat may optionally be provided as a separate layer to provide a laminated dough.

Protein is a preferred optionally additional ingredient that may be added to provide structural and textural benefits in addition to frozen shelf-life extension and coloration. Protein may be used in a range between 1% and 10% by weight. Protein sources include dairy (e.g. milk and egg), wheat, high protein flour and any combination thereof.

Other ingredients may be added to the dough such as preservatives, flavorings, spices or browning agents and the like. The dough can also include a sweetener, which may be provided either as a natural or artificial sweetener or as a liquid or dry ingredient. Suitable sweeteners include but are not limited to lactose, sucrose, fructose, dextrose, maltose, corresponding sugar alcohols, corn syrup, malt, hydrogenated corn syrup, maltodextrin, and mixtures thereof. Such sweeteners may act either or both as flavoring agents, texturizing, or browning agents. Enrichment nutrients which may be added to the dough may include thiamine, riboflavin, niacin, iron, calcium, and mixtures thereof. Other ingredients which may optionally be added to the dough mixture include dough seasonings, extenders, and food colorings as desired.

Doughs of the present invention may optionally include additional flavoring agents. Such flavoring agents include but are not limited to such ingredients as salt, milk and milk products, eggs and egg products, cocoa, whey, malt, yeast, yeast extract, inactivated yeast, spices, herbs, and vanilla. The optional flavoring agent preferably comprises from above about 0.1 percent by weight, and more preferably from about 0.5 and about 5.0 percent by weight of the dough.

Starches and proteins may be added as a separate component to the dough formulation in order to assist in building viscosity, binding water, and trapping gases.

Small amounts of gums may be added to the dough present invention, for example, to improve shelf life. It has been found, however, that the addition of too much gum results in excess gumminess and, in some cases, a deleterious effect on flavor. Gums that may cause problems in the baked dough product of the present invention that are particularly to be avoided in large quantities are selected from the group consisting of karaya gum, guar gum, xanthan gum, carboxy methylcellulose, carrageenan gum, and mixtures thereof. Preferably, the dough contains no more than 0.4 percent by weight of the above listed gums, and more preferably contains no more than 0.2 percent by weight of the above listed gums. Most preferably, the dough composition of the present invention contains no more than 0.05 percent by weight of the above listed gums.

Preservatives may also be present in the dough of the present invention, and provide shelf-life extension for the baked product. Examples of preferred preservatives include, for example, potassium sorbate, sorbic acid, sodium propionate, and sodium diacetate. The dough may preferably comprise preservatives in an amount of from about 0.1 percent to about 2.5 percent by weight of the dough.

Preferably, the dough has a water activity of between about 0.93 and 0.97.

As noted above, a preferred embodiment of the present invention comprises a dough product having a filling. For purposes of the present invention, a filling is a non-dough composition that provides complementary flavor and/or textural properties to the dough product. The filling may lie on top of the dough portion of the product, or may be partially or fully enrobed in the dough portion of the product. The filling may be a raw or cooked food product. The filling can have a uniform consistency or a chunky consistency. In preferred embodiments, the filling is a highly viscous liquid, suspension or pseudoliquid, i.e., a flowable mixture of particulates and/or liquid that may not normally be a liquid or a suspension. The material preferably is highly viscous such that it will not flow immediately through any imperfection in a dough covering or out from the ends of seams of the product when cut and crimped after formation.

The filling can be made from any type or types of food ingredients, including savory or sweet ingredients. Examples of savory ingredients include but are not limited to meat, vegetable, and dairy ingredients. Alternatively, the filling may be savory in flavor, such as cheese flavored, beef, chicken and the like. When the filling is savory, the filling composition preferably comprises a base savory component, such as cheese, beef gravy, chicken gravy or the like, and also includes a fat in this base component. Flavorants, such as herbs and spices, are additionally provided according to taste.

Examples of sweet ingredients include but are not limited to flavors such as cinnamon, maple syrup, or fruit such as orange, blueberry, or any other desired flavor. Both savory and sweet fillings may further include spices, herbs, flavoring agents, fats, and the like. The filling may further include such ingredients as preservatives and consistency modifiers such as emulsifiers and thickening agents.

The filling preferably has a water activity that is compatible with the dough. By this is meant that the water activities of the dough and the filling are selected such that water transfer from one material to another during storage (particularly during refrigerated or frozen storage) has minimal deleterious effects to either the filling or the dough of the dough product. Preferably, the water activity of the filling and the dough composition is selected such that there is no deleterious visual effect to either component over the expected storage time of the product. Additionally, the water activity of the filling and the dough composition is preferably selected such that there is no deleterious organoleptic effect to either component over the expected storage time of the product. Preferably, the filling has a water activity between about 0.77 and 0.97.

A dough composition of the present invention is prepared by mixing the ingredients as described above in conventional mixing equipment known in the baking arts, and segregating the dough into individual sized portions. The dough may be mixed, for example, by batch processes or continuous processes. The dough products may be formed by portioning, sheeting or extrusion processes as are known in the art. For example, conventional single screw food extruders or twin screw extruders may be used to mix and form dough products by extruding the dough compositions of the present invention. Combination extruder devices that utilize single screw and twin screw components are also contemplated.

In a particularly preferred embodiment of the present invention, the dough composition is prepared in a lower temperature extrusion process wherein the dough comprises pre-gelatinized starch comprising at least about 75 percent amylopectin, flour, leavening agent, water and PGA. This dough composition is extruded through a die under conditions so that the dough composition does not exceed 140° F. throughout the extrusion process. The pre-gelatinized starch, flour, leavening agent and water are present in an amount so that the resulting dough product has a baked specific volume (“BSV”) of greater than about 3.0 cc/g. This lower temperature extrusion process is described in more detail in U.S. patent application Ser. No. 10/068,561, filed Feb. 5, 2002, now U.S. Pat. No. 6,881,429, the disclosure of which is hereby incorporated by reference. It has been found that the addition of PGA to compositions as described therein provides specific textural benefits in the resulting extruded product.

In the context of the lower temperature extrusion process, the term “extrusion” or “extruding” as used herein refers to a process of forcing a dough composition through an orifice under pressure of at least about 50 p.s.i., and typically from about 50 to about 150 p.s.i. The starch component of the dough composition to be used in this embodiment of the present invention is a pregelatinized starch, meaning that the starch is gelatinized prior to adding to the other ingredients of the dough composition. While ungelatinized starch is insoluble in water at 20° C. (68° F.), gelatinized starch is water soluble. Thus, a 5 gram sample of gelatinized starch mixed in 100 ml water has no visible insoluble components. The pre-gelatinized starch comprises at least about 75 percent amylopectin, more preferably at least about 80 percent, and most preferably at least about 90 percent of amylopectin. Pre-gelatinized starch is preferably present in the dough composition of this embodiment of the invention in amounts of from about 1 to about 12 percent by weight, and more preferably from about 2 percent to about 7 percent by weight of the total dough composition. During the extrusion process of this embodiment, the temperature of the dough must remain below about 140° F. While not being bound by theory, it is believed that this temperature cap is required to assure that any starches present in other ingredients of the dough composition, such as natural starches present in flour and like, do not gelatinize; and further that any proteins present in the composition do not denature. Maintenance of the dough at this desired temperature is preferably accomplished by ensuring that the temperature of the extruder does not exceed 140° F. Preferably, the dough is maintained at a temperature below about 120° F., and more preferably below about 100° F. As above, this temperature maximum is preferably achieved by maintenance of the temperature of the extruder below the desired temperature of the dough.

Typically, individual portions of dough products are from about 0.5 to 8 oz in weight, more preferably from about one to about five ounces in weight. The dough may be proofed prior to segregation into individual portions, or preferably may be proofed after segregation into individual portions. After proofing, the portions may be baked in an appropriate manner, time and temperature as is readily apparent to the routineer in this art, such as by baking in a conventional oven or a convection oven, so that the baked dough product has a BSV of about 2.5 to about 6 cc/g. The thus prepared baked dough product may be immediately served, or stored at room temperature (i.e. at about 21° C.), at refrigeration temperature or at frozen temperature.

In one preferred embodiment, dough products of the present invention are mixed and formed in a continuous extrusion process. In these embodiments, leavening takes place in process in the extrusion, optionally by using injected gases such as nitrogen or carbon dioxide gas to provide the leavening without reaction of chemical leavening agents or reliance on yeast. This extrusion process may include coextrusion with a filling, so that the resulting product as it exits the extruder is a filled extrusion product having the desired flavor and textural properties as described herein.

In a preferred embodiment of the present invention, the dough product is stored prior to baking in a refrigerated environment, and baked later. The dough product of this embodiment may optionally be stored in a proofed state, ready for immediate baking. In a particularly preferred embodiment, the dough product is stored as segregated portions that are packaged together in an unproofed state. In use, the segregated portions of dough are physically separated and proofed, thereby allowing the segregated portions to expand immediately prior to baking. Alternatively, the segregated portions of dough may be immediately baked without a separate proofing step. Proofing in this embodiment takes place in the oven. Most preferably, the dough is disposed within a pressurized container in a partially proofed state. Expansion of the dough product substantially occurs immediately after removal of the product from the pressurized container. Examples of such pressurized containers are described in U.S. Pat. Nos. 3,981,433; 4,381,315; 4,415,598; and 5,084,284, the disclosures of which are incorporated herein by reference. Particularly preferred products of the present invention are laminated biscuits stored in pressurized containers. Most particularly preferred products are laminated biscuits stored in pressurized containers additionally comprising a filling, such as a cinnamon filling.

In another embodiment of the present invention, the dough is stored in a frozen state, either as proofed dough or as unproofed dough. The dough optionally may be packaged in bulk, thawed and segregated into individual portions either before or after a proofing step. Preferably, segregation into individual portions is carried out before proofing, so that the structure of the dough product is not disturbed after proofing. More preferably, the dough is stored in segregated portions that are packaged together in the frozen state. In one embodiment, the segregated portions may be proofed and then baked to provide a baked dough product, preferably having a BSV of about 2.5 to about 6 cc/g. More preferably, the frozen individual portions of dough are placed directly into the oven without an intermediate thawing and proofing step.

In yet another embodiment of the present invention, the dough is stored as a baked dough product in a refrigerated or a frozen state.

The present invention is particularly advantageous for products that are stored for a period of time before consumption, because some undesired modification of the textural properties of the baked dough product typically occurs during storage. This undesired textural modification may occur whether the product is stored in the unbaked unproofed state, the unbaked proofed state, or as a baked product. In particular, refrigerated storage of dough products, either before or after baking, often results in modification of the texture of the product such that the product no longer presents the freshly made and baked sensation desired by consumers. Similarly, frozen storage of dough products, either before or after baking, often also results a texture that is less than optimal from the perspective of consumers. The incorporation of PGA as provided herein substantially improves the textural properties of the ultimate baked dough product, even after refrigerated or frozen storage, without adverse effect with respect to flavor of the product.

Springiness Evaluation

A compression/release test has been developed to quantify the ‘springiness’ of a bread sample. The details of the test are as follows:

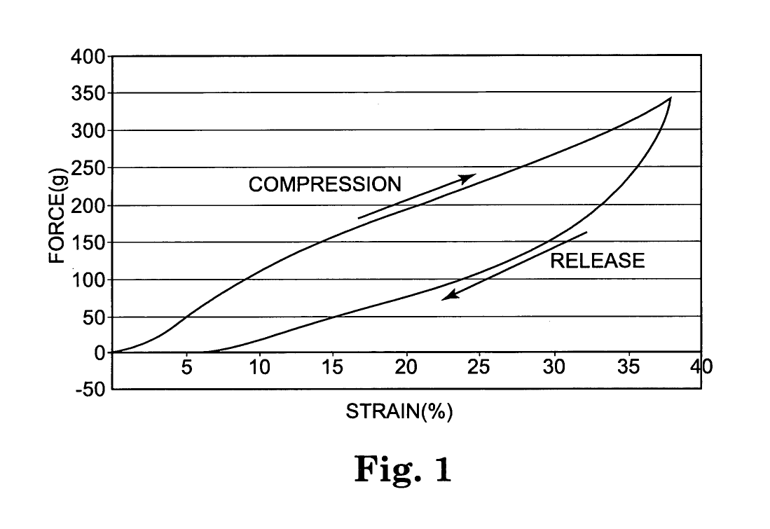

A crumb sample is cut from the interior of the dough product to be evaluated, making sure to remove all crust (sample size should be about 2.5 cm cube, or cylindrical with diameter of 2.5 cm and height 2.5 cm, exact dimensions are not critical but it is important that the top and bottom surfaces be flat and parallel). The sample is compressed to 40-50% strain then released at a speed of 0.1 mm/sec while continuously monitoring force. Any appropriate device may be used for this measurement, such as an Ares rheometer. Under these conditions, the curve as shown in FIG. 1 is generated. ‘Springiness’ is then calculated as the ratio of the area under the release curve divided by the area under the compression curve.

The invention will further be described by reference to the following non-limiting examples.

### EXAMPLE 1

Bread rolls are made for evaluation of the present invention according to the recipes as follows:

| | 1A (comparative) | 1B | 1C |
|---|---|---|---|
| Ingredient | % | % | % |
| flour | 57 | 56.9 | 56.8 |
| water | 29.28 | 29.28 | 29.28 |
| vegetable oil | 5.5 | 5.5 | 5.5 |
| yeast | 1.2 | 1.2 | 1.2 |
| sugar | 5 | 5 | 5 |
| salt | 0.95 | 0.95 | 0.95 |
| whey solids | 0.77 | 0.77 | 0.77 |
| DATEM | 0.3 | 0.3 | 0.3 |
| PGA | 0.0 | 0.1 | 0.2 |

These ingredients are mixed for 9 minutes in a mechanical dough mixer on high speed, divided and rounded to the desired shape of the dough product. The product is proofed to double initial dough volume, and baked for 16 minutes at 375° F. The baked product is allowed to cool, and is frozen in plastic bags. The product is stored for 3 to four weeks, and allowed to thaw at room temperature in the bag for two hours. The Springiness Values as determined by the test described above are as follows:

| | Comparative | | |
|---|---|---|---|
| | example 1A | example 1B | example 1C |
| Springiness Values | 0.41 | 0.48 | 0.54 |

Additionally, a panel of experienced taste testers evaluated the products of this Example, and made the following findings:

Comparative Example 1A was found to have low springiness from a personal perception, and also tended to be gummy. Example 1B exhibited good texture with increased springiness and less gumminess. Example 1C approached a product that was too springy, dry and tough.

### EXAMPLE 2

Biscuits are made for evaluation of the present invention according to the recipes as follows:

| | 2A (comparative) | 2B | 2C |
|---|---|---|---|
| Ingredient | % | % | % |
| flour | 45.32 | 45.27 | 45.22 |
| water | 28 | 28 | 28 |
| buttermilk solids | 3 | 3 | 3 |
| xanthan | 0.13 | 0.13 | 0.13 |
| Shortening | 14 | 14 | 14 |
| salt | 1.3 | 1.3 | 1.3 |
| Chemical leaveners | 2.25 | 2.25 | 2.25 |
| sugar | 5.5 | 5.5 | 5.5 |
| dough conditioner | 0.5 | 0.5 | 0.5 |
| PGA | 0.0 | 0.05 | 0.1 |

The above ingredients are mixed for seven minutes at high speed, cut to the desired shape, packaged and refrigerated. After storage, the product is baked at 375° F. for 14 minutes. After cooling, the Springiness Values of the product are determined by the test described above, with results as follows:

| | Comparative | | |
|---|---|---|---|
| | example 2A | example 2B | example 2C |
| Springiness Values | 0.33 | 0.42 | 0.45 |

Additionally, a panel of experienced taste testers evaluated the products of this Example, and made the following findings:

Comparative Example 1A was found to be too moist and gummy. Example 1B exhibited good texture with increased springiness and less gumminess. Example 1C approached a product that was too springy, dry and tough.

The embodiments described herein are illustrative in nature and not intended to limit the scope of the invention. One skilled in the art will recognize that variations are possible without departing from the spirit or scope of the invention.

1. A method for providing dough products having an improved springy texture when baked, the method comprising:
a) identifying a dough product recipe comprising flour, water and a leavening system in amounts sufficient to provide a leavened dough product, wherein the product of the dough recipe, when baked, has a Springiness Value of less than about 0.35; and
b) preparing a springy dough product in accordance with the recipe identified in step a), and additionally comprising propylene glycol alginate in an amount sufficient to provide a baked dough product having a Springiness Value of about 0.35 to about 0.55.

2. The method claim 1, wherein the dough product is a biscuit, and the springy dough product with propylene glycol alginate has a Springiness Value of about 0.35 to about 0.45.

3. A method for providing bread dough products having an improved springy texture when baked, the method comprising:
a) identifying a bread dough product recipe comprising flour, water and a leavening system in amounts sufficient to provide a leavened dough product, wherein the product of the dough recipe, when baked, has a Springiness Value of less than about 0.45; and
b) preparing a springy dough product in accordance with the recipe identified in step a), and additionally comprising propylene glycol alginate in an amount sufficient to provide a baked dough product having a Springiness Value of about 0.45 to about 0.55.

4. The method of claim 1, wherein said propylene glycol alginate is present in the springy dough product in an amount of about 0.01 to about 0.15% by weight of the total dough composition.

5. The method of claim 1, wherein the springy dough product further comprises gum in an amount no more than 0.4 percent by weight of the dough.

6. The method of claim 1, wherein the springy dough product further comprises gum in an amount no more than 0.2 percent by weight of the dough.

7. The method of claim 1, wherein the springy dough product further comprises gum in an amount no more than 0.05 percent by weight of the dough.

8. The method of claim 1, wherein the springy dough product, when baked to provide a baked dough product, has a BSV of about 2.5 to about 6 cc/g.

9. The method of claim 1, wherein the springy dough product further comprises a dough conditioner.

10. The method of claim 9, wherein the dough conditioner is selected from the group consisting of mono- and diglycerides, mono- and di-glycerides of fatty acids, propylene glycol mono- and di-esters of fatty acids, glycerol-lacto esters of fatty acids, ethoxylated mono-glycerides, lecithin, protein, and mixtures thereof.

11. The method of claim 9, wherein the dough conditioner is selected from the group consisting of sodium stearoyl 2 lactylate, calcium stearoyl lactate, ethoxylated and succinylated monoglycerides, polysorbate 60, and mixtures thereof.

12. The method of claim 1, further comprising the step of baking the springy dough product in an oven.

13. The method of claim 1, further comprising the step of baking the springy dough product in an extrusion process.

14. The method of claim 1, further comprising the step of storing the springy dough product under refrigerated or frozen conditions.

15. The method of claim 14, wherein the springy dough product is disposed within a pressurized container in at least a partially proofed state.

16. The method of claim 14, wherein the springy dough product is frozen in an unproofed state.

17. A dough composition for providing a springy dough product comprising flour, water and a leavening system in amounts sufficient to provide a leavened biscuit or bread dough composition, wherein the dough composition comprises sufficient propylene glycol alginate that, when baked to provide a baked dough product, has a Springiness Value of about 0.35 to about 0.55.

18. The dough composition of claim 17, wherein the dough composition is a biscuit dough composition that, when baked to provide a baked biscuit product, has a Springiness Value of about 0.35 to about 0.45.

19. The dough composition of claim 17, wherein the dough composition is a bread dough composition that, when baked to provide a baked bread product, has a Springiness Value of about 0.45 to about 0.55.

20. A method of use of a dough composition of claim 17, comprising
a) providing a dough composition of claim 17, and
b) marketing the dough composition in combination with communications indicative of the improved springiness texture characteristics of the dough composition in comparison to like dough compositions that do not contain propylene glycol alginate.
